(19) United States
(12) Patent Application Publication
(10) Pub. No.: US 2024/0039287 A1
(43) Pub. Date: Feb. 1, 2024

(54) GENERATOR MULTITUDE

(71) Applicant: Michael Lee Bivens, Chicago, IL (US)

(72) Inventor: Michael Lee Bivens, Chicago, IL (US)

(21) Appl. No.: 17/958,398

(22) Filed: Oct. 2, 2022

Related U.S. Application Data
(60) Provisional application No. 63/369,756, filed on Jul. 28, 2022.

(51) Int. Cl. H02J 3/38

(52) U.S. Cl. CPC H02J 3/381; B60L 50/60

(57) ABSTRACT

A motor and generator unit made in a unique way to amplify power using a low power source like a AAA, AA, C, D, and 9-volt rechargeable batteries and more as a preferred embodiment. One use of this unit is to act as alternator in electric cars for more efficiency and safety. With this unit, a rechargeable AA battery can power a house.

### CROSS-REFERENCE TO RELATED APPLICATIONS

Application No. 63/369,759

### BACKGROUND OF INVENTION

### 1. Field of the Invention

The present invention is in the field of renewable energy.

### 2. Discussion of the State of the Art

On the market of generators, there are mainly two types. A solar generator and a gas generator. Both are not efficient enough to power a wide range of product in variety of ways. Also, they need a large amount of battery backup power and gas to run then for long periods of time. With the Generator Multitude, it can be used in a wide range of products that need to be powered by a little of electricity or a lot depending on how many electric motors and generators you add into the unit.

### BRIEF SUMMARY OF THE INVENTION

In one embodiment of the invention, electric motors and generators are connected from least to great to amplify power from a small power source. Using this method, a power source like a small rechargeable battery can power a house using this unit. Also, other varieties of power sources can be used to power the unit like solar panels, turbines and more. In one embodiment, rechargeable batteries are made up of toxic heavy metals and with this unit it cuts down on the use of using multiple batteries as a power source for safety. This makes it easy to recharge a single rechargeable battery.

### BRIEF DESCRIPTION OF THE DRAWING(S)

FIG. 1A is a mechanical overview of electric motors and generators enclosed in a shell working together as a unit while being power by an AA Battery.

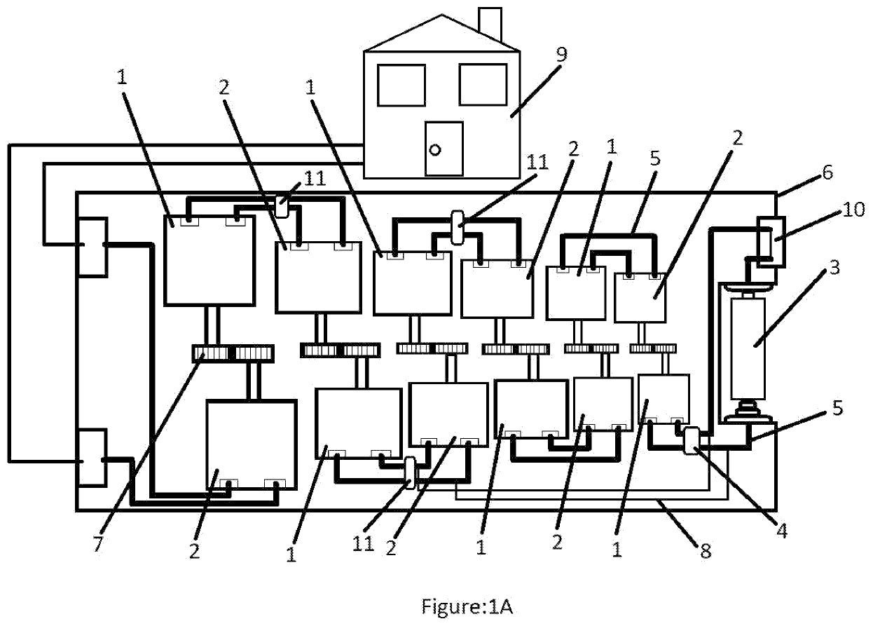

FIG. 1B is an overview without being numbered for a better view of the operation of the invention.

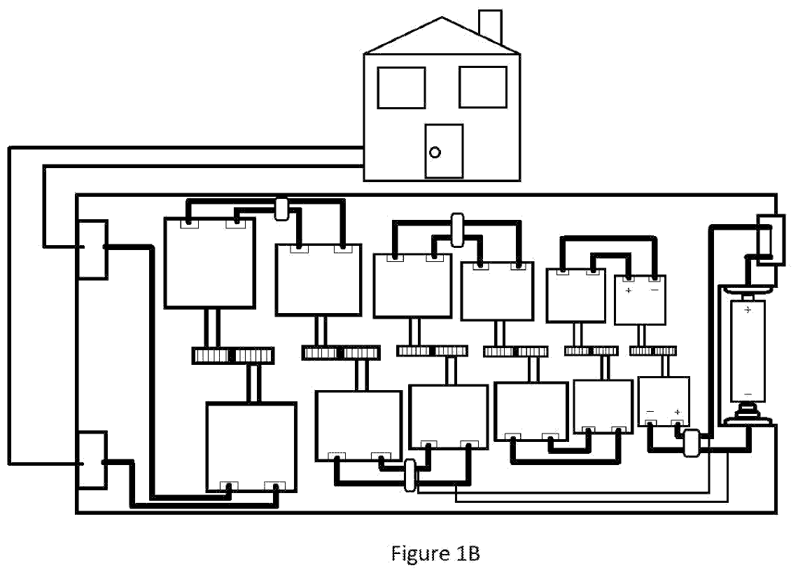

1. Electric Motor
2. Generator
3. AA Battery
4. Resistor
5. Copper Wire
6. Shell
7. Teeth
8. Recharging Battery Wire
9. House
10. Fuse
11. Voltage Amplifier

### DETAILED DESCRIPTION OF THE INVENTION

In one embodiment of the invention, motors and generators are connected from least to great to amplify power from a small power source like a rechargeable AA battery. Using this method, a power source like a small rechargeable battery can power a house or even a city depending in how many motors and generators from least to great is used to amplify voltage in a unit. Also, other varieties of power sources can be used to power the unit like solar panels, turbines and more. This invention method can be designed in many different ways using this method. This invention can be designed for vehicles, homes, cities, and much more. With all the components already tested and being sold on the market, this is the ideal solution for amplified power using less batteries as possible for safety do to rechargeable batteries are made with toxic metals and other sustainable energy sources. The alternator charges the battery in gas cars to keep it running and powered. The Generator Multitude Unit can work as a alternator for electric cars keeping it powered to drive long distances on a small battery making electric cars more efficient and safe.

1. A motor and generator unit made in a unique way to amplify power using a low power source like a AAA, AA, C, D, and 9-volt batteries and more as a preferred embodiment. One use of this unit is to act as alternator in electric cars for more efficiency and safety.
